(19) United States
(12) Patent Application Publication
(10) Pub. No.: US 2016/0214877 A1
(43) Pub. Date: Jul. 28, 2016

(54) PROCESS FOR PURIFYING WATER

(71) Applicant: KEMIRA Oyj, Helsinki (FI)

(72) Inventors: Vesa KETTUNEN, KEMPELE (FI); Maria LUHTALA, Upinniemi (FI)

(21) Appl. No.: 14/917,342

(22) PCT Filed: Sep. 8, 2014
(86) PCT No.: PCT/EP2014/069078

§ 371 Date: Mar. 8, 2016

(30) Foreign Application Priority Data
Sep. 9, 2013 (SE) 1351033-4

(51) Int. Cl. C02F 9/00; C02F 1/52; C02F 1/72; C02F 1/66

(52) U.S. Cl. CPC C02F 9/00; C02F 1/66; C02F 1/5236; C02F 1/722

(57) ABSTRACT

The present invention relates to a process for purification of water, comprising addition of an alkalinity affecting material, which material is chosen from calcium, sodium and/or magnesium containing compounds, addition of a coagulant containing ferric salt in an amount of about 3.5-40 mg Fe³⁺/l water to be purified, and addition of hydrogen peroxide in an amount of about 0.2 to 15 mg/I water to be purified, wherein said water to be purified has an alkalinity of about 0.05-0.9 mmol/l and an amount of total organic carbon (TOC) of 5-25 mg/l, and said alkalinity affecting material is added before the coagulant and hydrogen peroxide.

### FIELD OF THE INVENTION

The present invention relates to a treatment of low alkalinity waters to purify said waters by removing contaminants and make the waters potable.

### BACKGROUND ART

The primary purpose of water treatment is to remove contaminants from water. Water originating from natural sources may contain contaminants like organic compounds and microorganisms which need be removed before the water is suitable for human consumption. Many different ways to provide potable water are known. It is also known that depending on the contaminants present and properties of the water in question, some waters may be more difficult than others to purify.

It has been found that treatment of water having low alkalinity containing high amounts of organic matter and high amounts of humic substances may be very difficult to treat so that potable water of good quality is obtained.

U.S. Pat. No. 7,704,399 discloses a method for the treatment of water for human consumption. The method includes addition of a metal salt catalyst followed by addition of hydrogen peroxide, and thereafter air is supplied to provide a turbidity within a water line.

U.S. Pat. No.6,596,176 discloses a process for the purification of water including addition of hydrogen peroxide and metallic coagulants to remove contaminants. Hydrogen peroxide is added to a water source and thereafter metallic coagulants, optionally mixed with polydimethyldiallylammonium chloride, are added.

WO 2011/026758 discloses a method of purifying water in a river or canal by addition of hydrogen peroxide, followed by addition of a metal salt of Al³⁺ or Fe³⁺ as a coagulant, addition of a polymeric flocculant and injecting air bubbles for floatation, after the main part of the hydrogen peroxide added has been consumed.

### SUMMARY

An object of the present invention is to provide a process for purification of water, comprising addition of an alkalinity affecting material, which material is chosen from calcium, sodium and/or magnesium containing compounds, addition of a coagulant containing ferric salt in an amount of about 3.5-40 mg Fe³⁺/l water to be purified, and addition of hydrogen peroxide in an amount of about 0.2 to 15 mg/l water to be purified, wherein said water to be purified has an alkalinity of about 0.05-0.9 mmol/l and an amount of total organic carbon (TOC) of 5-25 mg/l and said alkalinity affecting material is added before the coagulant and the hydrogen peroxide.

Addition of hydrogen peroxide may be made in an amount of about 0.2 to 10 mg/l water to be purified, preferably about 0.2 to 6 mg/l, preferably about 0.2 to 5 mg/l, e.g. about 0.2 to 4 mg/l, about 0.2 to 3 mg/I, or about 0.2 to 2.5 mg/l.

According to one embodiment an alkalinity affecting material is added, which material is chosen from calcium, sodium or magnesium containing compounds.

According to one embodiment said alkalinity affecting material is chosen from Ca(OH)₂, CaO, CaCO₃, NaOH, Na₂CO₃, MgO or Mg(OH)₂, preferably Ca(OH)₂, CaO, or CaCO₃.

According to one embodiment the hydrogen peroxide may be added before, after or simultaneously with the coagulant, preferably the hydrogen peroxide is added before the coagulant.

According to one embodiment the coagulant containing ferric salt comprises ferric salt selected from any one of ferric sulfate, ferric chloride, ferric sulfate chloride and ferric chlorohydrate, or any combination thereof.

According to one embodiment the coagulant is present in an amount of about 6-32 mg Fe³⁺/l water to be purified, preferably about 10-25 mg/l, e.g. 15-25 mg/l.

According to one embodiment the pH of the water after addition of coagulant and hydrogen peroxide is about 4-6, and preferably about 4.5-5.5.

According to one embodiment the water to be purified is surface water. According to one embodiment the hydrogen peroxide is added in an amount of 0.5-10 mg/l, preferably 0.5-5 mg/l.

According to one embodiment the water to be purified has an alkalinity of 0.1-0.6 mmol/l, e.g. 0.1-0.4 mmol/l.

According to one embodiment said alkalinity affecting material is added in an amount effective to increase the alkalinity of the water to about 1-2 mmol/l.

### DETAILED DESCRIPTION

The present process relates to purification of water, such as surface water, by addition of a coagulant containing a ferric salt (Fe³⁺ salt), and hydrogen peroxide. Optionally, an alkalinity affecting material may be added. Water to be purified according to the present method has a low alkalinity. By low alkalinity is herein meant an alkalinity of about 0.05-0.9 mmol/l. The alkalinity is herein measured according to the standard SFS 3005 in accordance with the Finnish Standards Association (SFS). The method in said standard relates to alkalinity and acidity in water by potentiometric titration.

The water to be treated according to the present process is preferably surface water. Surface water is water on the surface of the planet such as in a stream, river, lake, or wetland. In untreated surface water, a typical value for total organic carbon (TOC) is about 5-25 mg/l and it has a colour about 10-250 mg/l Pt (Platinum/cobalt color). Both TOC and colour describe the characteristic of surface water that may be treated according to the present process. Total organic carbon (TOC) is the amount of carbon bound in an organic compound and is often used as a non-specific indicator of water quality. Herein TOC is measured by Liquid Chromatography—Organic Carbon Detection (LC-OCD). The method is used for fractionation and quantitative analysis of water-soluble natural organic matter. Molecules in a water sample are separated into fractions of different molecular weight by size-exclusion chromatography, and thereafter detected by ultraviolet detectors (UVD, 254 nm) and organic carbon detectors (OCD). The column was calibrated with IHSS humic and fulvic acid standards to provide molecular weight data of the humics.

The present process may be performed continuously, intermittent or batchwise. Preferably a continuous process is used.

Addition of coagulant, hydrogen peroxide and optionally alkalinity affecting material is preferably made continuously. After the addition of the mentioned chemicals, there may be a period of mixing, preferably slow mixing. The mentioned mixing period may be about 10-60 min. During this time flocs, suspended solids, are forming and growing, preferably to a size suitable for an efficient subsequent removal step for the suspended solids, such as sedimentation and/or flotation. Addition of further chemicals before the removal step is normally not necessary. However, flocculants could be added in order to increase the floc size. Examples of suitable flocculants are polymeric flocculants, such as polyacrylamide.

The coagulant comprising ferric iron (Fe³⁺) salt preferably consists mainly of said salt. More preferably the coagulant consists only of ferric iron salt, i.e. the coagulant is ferric iron salt. The ferric iron salt may be chosen from any one of ferric sulfate, ferric chloride, ferric sulfate chloride and ferric chlorohydrate, or any combination thereof.

The amount of hydrogen peroxide used is disclosed as 100% hydrogen peroxide. Hydrogen peroxide is typically dosed as 5-50 weight-% water solution.

Alkalinity affecting materials that are to be used in the present process, are to be added before any coagulant and hydrogen peroxide are added. The alkalinity affecting material is preferably added in an amount effective to increase the alkalinity of the water to about 1-2 mmol/l. As alkalinity increasing materials calcium, sodium and magnesium containing compound may be used, preferably chosen from any one of Ca(OH)₂, CaO, CaCO₃, NaOH, Na₂CO₃, MgO and Mg(OH)₂, or any combination thereof, preferably Ca(OH)₂, CaO, or CaCO₃, or any combination thereof.

The subsequent addition of said coagulant and hydrogen peroxide then results in a decrease of the alkalinity. The pH of the water after addition of coagulant and hydrogen peroxide is about 4-6, and preferably about 4.5-5.5.

The process according to the present invention provides a decrease in turbidity of the treated waters. A turbidity of about 0.40-1.50 NTU, e.g. 0.50-1.25 NTU, may be obtained. Turbidity in NTU involves measurements using a a calibrated nephelometer. Turbidity measurements gives an indication of the amount of solids in water.

The process according to the present invention provides a decrease in UV absorbance for the treated waters. A UV absorbance at 254 nm of about 0.010-0.050, e.g. 0.028-0.040, may be obtained. UV absorbance is measured by spectrophotometer. UV absorbance measurements gives an indication of the amount of organic matter in water.

The process according to the present invention provides a decrease in the amount of TOC for the treated waters. TOC values, measured by Liquid Chromatography—Organic Carbon Detection (LC-OCD), of about 1.80-2.50 mg/l, e.g. 2.10-2.44 mg/l, may be obtained. Examples

The surface water to be treated had an alkalinity of about 0.14 mmol/l and TOC was 10.6 mg/l. The experiments were carried out in 1 litre beakers with Kemira's Flocculator 2000. This flocculator can handle up to six glass beakers. Each beaker was equipped with a stirrer with an individual motor.

The rotational speed of the propeller and the time of the rotation can be regulated individually for all the beakers. Operating parameters were: Fast mixing at 400 rpm of said surface water; addition of 10 weight-% Ca(OH)₂ solution; fast mixing at 400 rpm for 30 seconds; addition of ferric sulfate solution that contained 12.5 weight-% Fe³⁺ (PIX-322, Kemira Oyj); fast mixing at 400 rpm for 30 seconds; addition of 10 w-% H₂O₂ solution; slow mixing at 40 rpm for 20 minutes; sedimentation for 20 minutes.

Experiments were also carried out so that addition order of the ferric sulfate solution and 10 weight-% H₂O₂ solution were the opposite. The pH after addition of all of these chemicals was varying between 4.5-5.5. The dose of 10 weight-% Ca(OH)₂ solution was pre-determined to correspond to the desired pH after Fe³⁺ and H₂O₂ dosing. The doses of ferric sulfate solution were 18.1, 20.6 and 23.1 mg Fe³⁺/l of treated water. The doses of H₂O₂ were 1, 2.5 and 5 mg/l of treated water (calculated as 100 weight-%).

The following analyses carried out from the clear fraction of the sedimented samples: Turbidity (Nephelometric Turbidity Units, NTU), UV absorbance at 254 nm, and Total organic carbon (TOC). The results can be seen in Tables 1 and 2.

TABLE 1
Turbidity, UV absorbance and TOC results of different treatments.

| 10% Ca(OH)₂ | Fe³⁺ | H₂O₂ | | Turbidity | UV abs at | TOC |
|---|---|---|---|---|---|---|
| μl/l | mg/l | mg/l | pH | NTU | 254 nm | mg/l |
| — | — | — | 6.35 | 1.60 | 0.524 | 10.65 |
| 270 | 18.1 | — | 4.5 | 3.32 | 0.044 | — |
| 310 | 18.1 | — | 5.53 | 2.18 | 0.068 | 3.55 |
| 250 | 18.1 | — | 6.0 | 0.97 | 0.088 | 3.31 |
| 270 | 18.1 | 1 | 4.53 | 1.07 | 0.035 | 2.13 |
| 269 | 18.1 | 2.5 | 5.04 | 0.92 | 0.040 | 2.10 |
| 281 | 18.1 | 2.5 | 5.5 | 0.65 | 0.045 | 2.22 |
| 250 | 18.1 | 2.5 | 6.05 | 0.57 | 0.051 | 2.44 |
| 263 | 18.1 | 5 | 4.5 | 1.10 | 0.034 | — |
| 290 | 20.6 | — | 4.5 | 1.16 | 0.041 | — |
| 320 | 20.6 | 1 | 4.46 | 0.85 | 0.030 | — |
| 290 | 20.6 | 2.5 | 4.52 | 0.70 | 0.030 | — |
| 300 | 20.6 | 5 | 4.49 | 0.66 | 0.029 | — |
| 360 | 23.1 | — | 4.57 | 1.28 | 0.038 | — |
| 375 | 23.1 | — | 5.5 | 2.21 | 0.042 | — |
| 365 | 23.1 | 1 | 4.51 | 1.21 | 0.029 | — |
| 350 | 23.1 | 2.5 | 4.98 | 0.55 | 0.030 | — |
| 375 | 23.1 | 2.5 | 5.47 | 0.53 | 0.034 | — |
| 380 | 23.1 | 5 | 4.5 | 0.99 | 0.028 | — |

TABLE 2
Turbidity and UV absorbance results of different treatments.

| 10% Ca(OH)₂ | H₂O₂ | Fe³⁺ | | Turbidity | UV abs at |
|---|---|---|---|---|---|
| μl/l | mg/l | mg/l | pH | NTU | 254 nm |
| — | — | — | 6.35 | 1.60 | 0.524 |
| 270 | — | 18.1 | 4.5 | 3.32 | 0.044 |
| 256 | 1 | 18.1 | 4.5 | 0.56 | 0.037 |
| 290 | — | 20.6 | 4.5 | 1.16 | 0.041 |
| 310 | 2.5 | 20.6 | 4.48 | 0.62 | 0.035 |

From these examples one may see that the turbidity of the examples are dependent on the addition of hydrogen peroxide and the amount of iron compound used.

Further, the examples show the influence on the UV absorbance. The examples disclose the impact with/without hydrogen peroxide as well as different amounts of iron compound used.

The examples also show the influence on the TOC. The examples disclose the impact with/without hydrogen peroxide as well as different amounts of iron compound used. The TOC is highly influenced by the additions.

1. A process for purification of water, comprising
addition of an alkalinity affecting material, which material is chosen from calcium, sodium and/or magnesium containing compounds,
addition of a coagulant containing ferric salt in an amount of 3.5-40 mg Fe³⁺/l water to be purified, and
addition of hydrogen peroxide in an amount of 0.2 to 15 mg/l water to be purified, wherein said water to be purified has an alkalinity of 0.05-0.9 mmol/l and an amount of total organic carbon (TOC) of 5-25 mg/l, and
said alkalinity affecting material is added before the coagulant and the hydrogen peroxide.

2. The process according to claim 1, wherein said alkalinity affecting material is chosen from Ca(OH)₂, CaO, CaCO₃, NaOH, Na₂CO₃, MgO or Mg(OH)₂, preferably Ca(OH)₂, CaO, or CaCO₃.

3. The process according to claim 1, wherein the hydrogen peroxide may be added before, after or simultaneously with the coagulant, preferably the hydrogen peroxide is added before the coagulant.

4. The process according to claim 1, wherein the coagulant comprises ferric sulfate, ferric chloride, ferric sulfate chloride or ferric chlorohydrate, or any combination thereof.

5. The process according to claim 1, wherein the coagulant is present in an amount of about 6-32 mg Fe³⁺/l water to be purified, preferably about 10-25 mg/l.

6. The process according to claim 1, wherein the pH of the water after addition of coagulant and hydrogen peroxide is about 4-6, and preferably about 4.5-5.5.

7. The process according to claim 1, wherein the water to be purified is surface water.

8. The process according to claim 1, wherein the hydrogen peroxide is added in an amount of 0.5-10 mg/l, preferably 0.5-5 mg/l.

9. The process according to claim 1, wherein the water to be purified has an alkalinity of 0.1-0.6 mmol/l.

10. The process according to claim 1, wherein said alkalinity affecting material is added in an amount effective to increase the alkalinity of the water to about 1-2 mmol/l.
